(19) United States
(12) Patent Application Publication
(10) Pub. No.: US 2014/0041398 A1
(43) Pub. Date: Feb. 13, 2014

(54) BOIL-OFF GAS PROCESSING APPARATUS AND LIQUEFIED GAS TANK

(71) Applicant: Eiji Aoki, Tokyo (JP)

(72) Inventor: Eiji Aoki, Tokyo (JP)

(73) Assignee: JAPAN MARINE UNITED CORPORATION, Tokyo (JP)

(21) Appl. No.: 14/111,017

(22) PCT Filed: Apr. 27, 2012
(86) PCT No.: PCT/JP2012/061423

§ 371 Date: Oct. 10, 2013

(30) Foreign Application Priority Data
May 2, 2011 (JP) 2011-102884

(51) Int. Cl. F25J 1/00; F17C 3/02

(52) U.S. Cl. CPC F25J 1/0025; F17C 3/02
USPC 62/48.2; 220/560.12

(57) ABSTRACT

A boil-off gas processing apparatus for reliquefying a boil-off gas (22) generated within a liquefied gas tank (2) storing a liquefied gas (21) and returning the reliquefied gas to the interior of the liquefied gas tank (2) includes a boil-off gas discharge line (3) configured to discharge the boil-off gas (22) from the liquefied gas tank (2) to outside, and a boil-off gas reliquefaction line (4) configured to immerse at least part of the boil-off gas discharge line (3) in the liquefied gas (21) within the liquefied gas tank (2). The boil-off gas reliquefaction line (4) includes a pressure holding device (42) configured to maintains a pressure necessary for reliquefaction of the boil-off gas (22) and has a length (L) sufficient to be able to absorb an amount of heat necessary for reliquefaction of the boil-off gas (22).

### TECHNICAL FIELD

The present invention relates to boil-off gas processing apparatus and liquefied gas tanks, and more particularly, to a boil-off gas processing apparatus for reliquefying a boil-off gas and returning the reliquefied gas to a liquefied gas tank, and a liquefied gas tank equipped with the boil-off gas processing apparatus.

### BACKGROUND ART

Generally, liquefied gases such as liquefied natural gas (LNG) and liquefied petroleum gas (LPG) are enclosed and stored in liquefied gas tanks installed at facilities or equipment, for example, in liquefied gas fuel tanks in tankers, import bases, stockpiling bases and marine vessels. Such a liquefied gas tank, even if provided with heat insulation, is subject to heat penetrating into the interior of the tank from outside to no small extent, and the liquefied gas evaporates due to the penetration heat.

If the evaporative gas (hereinafter referred to as “boil-off gas”) is not removed from the liquefied gas tank to the outside, the gas vapor pressure in the liquefied gas tank rises, and the liquefied gas within the liquefied gas tank reaches a vapor-liquid equilibrium at a saturated vapor pressure dependent on the surface temperature of the liquefied gas. Also, the warmed liquefied gas collects in the surface region of the liquid in the liquefied gas tank because of the convection accompanying temperature rise, forming a liquid layer (upper high-temperature layer) higher in temperature than the liquefied gas as a whole. The vapor-liquid equilibrium is maintained between the upper high-temperature layer and the gas vapor phase.

Specifically, the heat that has penetrated into the liquefied gas tank is transferred to the upper high-temperature layer due to convection of the liquefied gas and raises the temperature of the upper high-temperature layer. Accordingly, the temperature of the upper high-temperature layer rises in a relatively short time, with the result that the pressure of the gas vapor phase equilibrating with the temperature of the upper high-temperature layer also rises. Since the upper high-temperature layer is thinner in thickness (smaller in amount) than a lower low-temperature layer that accounts for the most part of the liquefied gas, the pressure of the gas vapor phase rises up to a predetermined pressure (upper-limit value) of the liquefied gas tank in a relatively short time.

Thus, in conventional liquefied gas tanks for storing a liquefied gas under ordinary pressure, for example, the boil-off gas is transferred to an external gas processing apparatus by a compressor or the like, in order to keep the internal pressure of the liquefied gas tank at or below the predetermined pressure. Such a gas processing apparatus includes, for example, a reliquefying apparatus for cooling the boil-off gas by a low-temperature medium, such as nitrogen gas, to liquefy the boil-off gas and returning the liquefied gas to the liquefied gas tank, a gas consumption apparatus for burning the boil-off gas by a boiler, gas-fired engine or the like to use the boil-off gas as an energy source, a gas incineration disposal apparatus for disposing of the boil-off gas by incineration, and a discarding apparatus for releasing the boil-off gas to the atmosphere, such as a gas flaring apparatus and a gas venting apparatus.

In the boil-off gas processing method disclosed in Patent Document 1, a BOG (boil-off gas) return pipe branches off from an intermediate portion of a BOG removal pipe for removing the BOG generated within a low-temperature liquefied gas tank and is immersed in the liquid in the low-temperature liquefied gas tank such that the distal end of the BOG return pipe opens near the bottom of the tank. A net for forming BOG bubbles of small diameter is attached to a lower outlet formed at the distal end of the BOG return pipe so that the BOG introduced into the BOG removal pipe may be injected as small BOG bubbles from the BOG return pipe into the low-temperature liquefied gas through the net. With this processing method, the boil-off gas is reliquefied.

In the boil-off gas processing method disclosed in Patent Document 2, the BOG (boil-off gas) generated in a liquefied gas tank of a liquefied gas-carrying vessel is reformed and supplied as a fuel to a fuel cell so that electricity may be generated by the fuel cell. In this processing method, the boil-off gas is used as an energy source.

### CITATION LIST

### Patent Literature

Patent Document 1: Unexamined Japanese Patent Publication No. 2000-46295
Patent Document 2: Unexamined Japanese Patent Publication No. 2004-51049

### SUMMARY OF INVENTION

### Technical Problem

However, reliquefaction of the boil-off gas is associated with a problem that facility cost and operating cost are enormous, use of the boil-off gas as an energy source is associated with a problem that facility cost is enormous, and incineration or discard of the boil-off gas is associated with a problem of wastefulness.

In the reliquefying apparatus disclosed in Patent Document 1, the boil-off gas is directly injected in the form of bubbles into the liquefied gas tank, giving rise to a problem that the bubbles of the boil-off gas quickly rise up in the liquefied gas still in the form of bubbles, reach the liquid surface and return to the gas vapor phase.

On the other hand, the processing method disclosed in Patent Document 2 requires fuel cell facilities equipped with a fuel cell, a reformer and the like, and thus the facility cost is enormous. Also, where the boil-off gas is used as an energy source, the amount of generation of the boil-off gas sometimes exceeds the amount of energy consumption, and in such a situation, a problem arises in that the boil-off gas has to be eventually incinerated or discarded.

The present invention was created in view of the above problems, and an object thereof is to provide a boil-off gas processing apparatus and a liquefied gas tank whereby facility cost and operating cost needed for the processing of a boil-off gas can be reduced and also incineration or discard of the boil-off gas can be restrained.

### Solution to Problem

The present invention provides a boil-off gas processing method which reliquefies a boil-off gas generated within a liquefied gas tank storing a liquefied gas and returns the reliquefied gas to an interior of the liquefied gas tank. The boil-off gas processing apparatus includes a boil-off gas discharge line configured to discharge the boil-off gas from the liquefied gas tank to outside, and a boil-off gas reliquefaction line configured to immerse at least part of the boil-off gas discharge line in the liquefied gas within the liquefied gas tank, wherein the boil-off gas reliquefaction line maintains a pressure necessary for reliquefaction of the boil-off gas and has a length sufficient to be able to release an amount of heat necessary for reliquefaction of the boil-off gas.

Also, the present invention provides a liquefied gas tank including a heat-insulating container storing a liquefied gas, wherein the liquefied gas tank is equipped with a boil-off gas processing apparatus which reliquefies a boil-off gas generated within the liquefied gas tank and returns the reliquefied gas to an interior of the liquefied gas tank, the boil-off gas processing apparatus includes a boil-off gas discharge line configured to discharge the boil-off gas from the liquefied gas tank to outside, and a boil-off gas reliquefaction line configured to immerse at least part of the boil-off gas discharge line in the liquefied gas within the liquefied gas tank, the boil-off gas reliquefaction line maintains a pressure necessary for reliquefaction of the boil-off gas and has a length sufficient to be able to release an amount of heat necessary for reliquefaction of the boil-off gas.

In the above boil-off gas processing apparatus and liquefied gas tank, the boil-off gas reliquefaction line may include a pressure holding device configured to condense and trap the boil-off gas and release the boil-off gas in liquid form into the liquefied gas.

The boil-off gas reliquefaction line may be configured to reliquefy all of the boil-off gas to be released into the liquefied gas, or may be configured to reliquefy part of the boil-off gas to be released into the liquefied gas.

The boil-off gas processing apparatus may further include an outward guidance line configured to guide the boil-off gas reliquefaction line to outside of the liquefied gas tank, a pressure holding device attached to a distal end of the outward guidance line and configured to condense and trap the boil-off gas and release the boil-off gas in liquid form, and a return line configured to return the liquid released from the pressure holding device into the liquefied gas within the liquefied gas tank.

Also, the boil-off gas processing apparatus may further include a liquid receiver tank inserted between the pressure holding device and the return line to temporarily hold the liquid released from the pressure holding device.

Further, the boil-off gas discharge line may include a compressor configured to discharge the boil-off gas or to increase pressure of the boil-off gas.

### Advantageous Effects of Invention

In the above boil-off gas processing apparatus and liquefied gas tank according to the present invention, the boil-off gas reliquefaction line maintains a predetermined pressure and has a predetermined length, in order to allow heat transfer to take place between the boil-off gas in the boil-off gas reliquefaction line and the liquefied gas stored in the liquefied gas tank. Consequently, the boil-off gas can be reliquefied inside the boil-off gas reliquefaction line, and after being reliquefied, the boil-off gas can be released into the liquefied gas tank. No special reliquefying apparatus is therefore required, making it possible to reduce facility cost and operating cost needed for the processing of the boil-off gas.

Also, the boil-off gas in gas vapor phase can be discharged so that the internal pressure of the liquefied gas tank may not reach a predetermined pressure, and the discharged boil-off gas can be reliquefied and returned to the liquefied gas tank. Thus, incineration or discard of the boil-off gas can be restrained.

### BRIEF DESCRIPTION OF DRAWINGS

FIG. 1A schematically illustrates an overall configuration of a boil-off gas processing apparatus according to a first embodiment of the present invention.

FIG. 1B illustrates a schematic configuration of a vapor trap of the boil-off gas processing apparatus according to the first embodiment of the present invention.

FIG. 2 is a pressure-enthalpy diagram illustrating operation of the boil-off gas processing apparatus.

FIG. 3A illustrates a first modification of the boil-off gas processing apparatus shown in FIG. 1.

FIG. 3B illustrates a second modification of the boil-off gas processing apparatus shown in FIG. 1.

FIG. 3C illustrates a third modification of the boil-off gas processing apparatus shown in FIG. 1.

FIG. 4A illustrates a fourth modification of the boil-off gas processing apparatus shown in FIG. 1.

FIG. 4B illustrates a fifth modification of the boil-off gas processing apparatus shown in FIG. 1.

FIG. 4C illustrates a sixth modification of the boil-off gas processing apparatus shown in FIG. 1.

FIG. 5A schematically illustrates an overall configuration of a boil-off gas processing apparatus according to a second embodiment of the present invention.

FIG. 5B illustrates a modification of the boil-off gas processing apparatus according to the second embodiment of the present invention.

### DESCRIPTION OF EMBODIMENTS

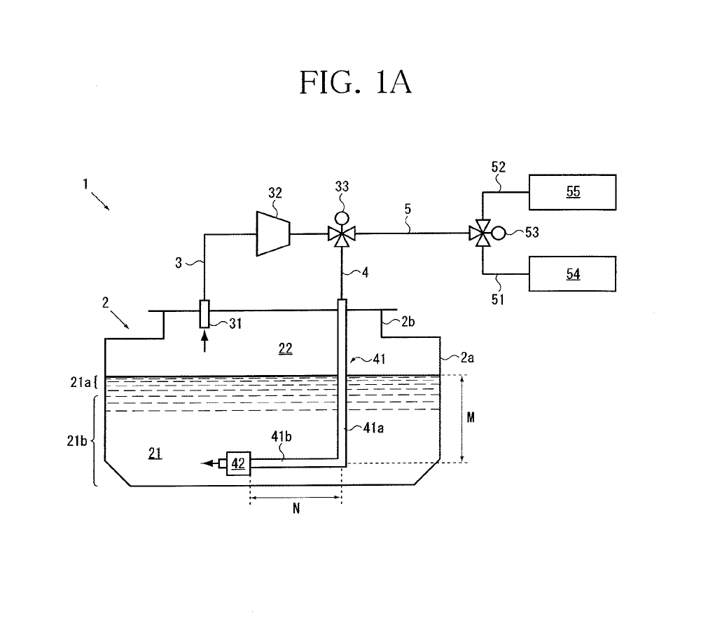

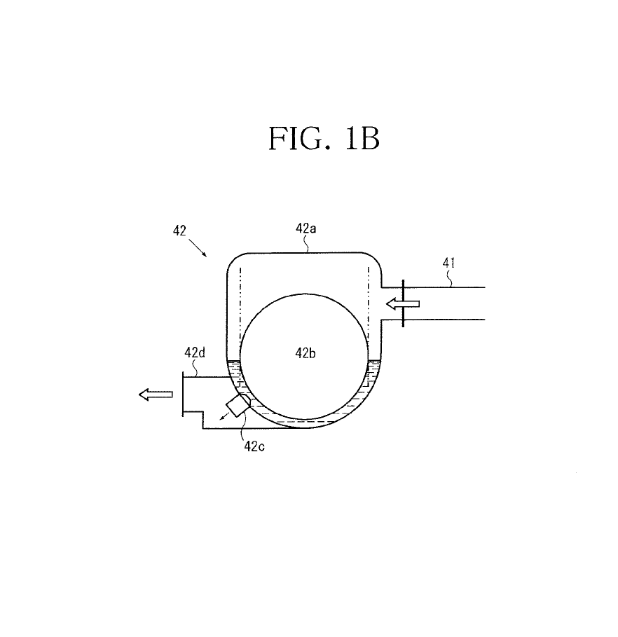

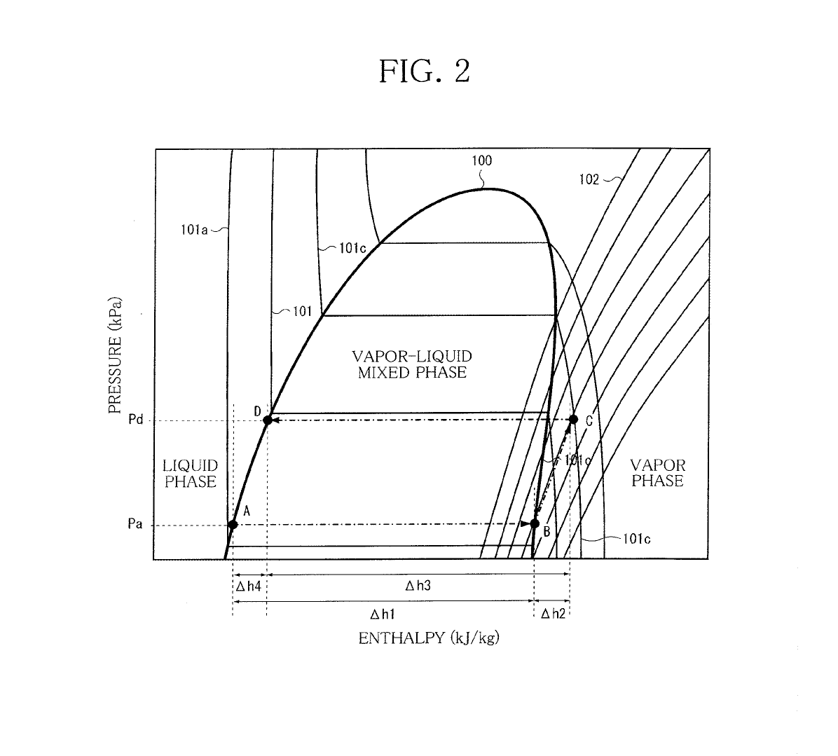

Embodiments of the present invention will be described below with reference to FIGS. 1 to 5. FIG. 1 illustrates a boil-off gas processing apparatus according to a first embodiment of the present invention, wherein FIG. 1A schematically illustrates an overall configuration of the apparatus, and FIG. 1B illustrates a schematic configuration of a vapor trap. FIG. 2 is a pressure-enthalpy diagram illustrating operation of the boil-off gas processing apparatus.

The boil-off gas processing apparatus 1 according to the first embodiment of the present invention is configured to reliquefy a boil-off gas 22 generated within a liquefied gas tank 2 storing a liquefied gas 21 and return the reliquefied gas to the interior of the liquefied gas tank and includes, as illustrated in FIG. 1A, a boil-off gas discharge line 3 configured to discharge the boil-off gas 22 from the liquefied gas tank 2 to outside, and a boil-off gas reliquefaction line 4 configured to immerse at least part of the boil-off gas discharge line 3 in the liquefied gas 21 within the liquefied gas tank 2, wherein the boil-off gas reliquefaction line 4 includes a pressure holding device 42 configured to maintain a pressure necessary for reliquefaction of the boil-off gas 22 and has a length L sufficient to be able to release an amount of heat necessary for reliquefaction of the boil-off gas 22.

The liquefied gas tank 2 illustrated in FIG. 1A has a heat-insulating container 2a storing the liquefied gas 21, and a tank dome 2b arranged at top of the heat-insulating container 2a. The construction of the liquefied gas tank 2 is not limited to the illustrated one and may be modified as needed so as to match installation locations or purposes of use, as liquefied gas fuel tanks in tankers, import bases, stockpiling bases or marine vessels.

The heat-insulating container 2a is constituted, for example, by an inner layer made of a material excellent in low-temperature toughness, a heat-insulating layer (or a low-temperature keeping layer) capable of suppressing penetration of heat from outside, and an outer layer supporting the heat-insulating layer. Also, the shape of the heat-insulating container 2a may be rectangular as illustrated, or spherical or cylindrical. The tank dome 2b is arranged at a roof part of the heat-insulating container 2a and has an insertion opening for piping or the like for introducing and removing the liquefied gas, as well as a passageway for maintenance work and the like.

The boil-off gas discharge line 3 includes a boil-off gas discharge pipe 31 inserted into an upper region of the interior of the liquefied gas tank 2, a compressor 32 for discharging the boil-off gas 22 or for increasing the pressure of the boil-off gas 22, and a flow channel selector valve 33 for changing the flow channel of the boil-off gas 22. In the figure, only part of the boil-off gas discharge pipe 31 is illustrated and also the piping constituting the boil-off gas discharge line 3 is illustrated in a simplified manner.

The boil-off gas discharge pipe 31 is inserted through the tank dome 2b of the liquefied gas tank 2 and opens into the interior of the liquefied gas tank 2. The boil-off gas discharge pipe 31 is arranged in such a position as to be able to suck in the boil-off gas 22 collecting in the upper region of the interior of the liquefied gas tank 2.

The compressor 32 sucks in the boil-off gas 22 collecting in the interior of the liquefied gas tank 2 and discharges the boil-off gas to the outside of the tank 2 through the boil-off gas discharge line 3. The compressor 32 may be configured to automatically start operating when the pressure in the liquefied gas tank 2 reaches a predetermined threshold, or may be operated manually at a desired time.

The boil-off gas discharge line 3 bifurcates, for example, into the boil-off gas reliquefaction line 4 and a boil-off gas consumption line 5. The flow channel selector valve 33 is arranged at the branching point of the boil-off gas discharge line 3. The flow channel selector valve 33 to be used need not be a three-way valve and may instead be stop valves respectively inserted in the boil-off gas reliquefaction line 4 and the boil-off gas consumption line 5. The boil-off gas consumption line 5 is used when the boil-off gas 22 is used as an energy source or for other purposes.

The boil-off gas consumption line 5 bifurcates into a first consumption line 51 and a second consumption line 52. A flow channel selector valve 53 is arranged at the branching point of the boil-off gas consumption line 5. The flow channel selector valve 53 to be used need not be a three-way valve and may instead be stop valves respectively inserted in the first and second consumption lines 51 and 52. The first consumption line 51 is connected, for example, to an engine 54, and the second consumption line 52 is connected, for example, to a boiler 55, so that the boil-off gas 22 is used as a fuel. When the amount of the boil-off gas 22 generated is greater than the amount of energy consumption, the boil-off gas 22 is guided to the boil-off gas reliquefaction line 4 and reliquefied.

The configuration of the boil-off gas consumption line 5 is not limited to the illustrated one, and where the gas consumption apparatus (engine 54, boiler 55 or the like) used is single in number, the boil-off gas consumption line 5 need not be bifurcated into the first and second consumption lines 51 and 52. On the other hand, where three or more gas consumption apparatus (engine 54, boiler 55, etc.) are used, the boil-off gas consumption line 5 may be configured to diverge into as many branch consumption lines as the gas consumption apparatus used. Further, the gas consumption apparatus to be used may be a suitable combination of identical or different types of single or multiple gas consumption apparatus (engine, boiler, etc.) and, if necessary, may include a gas incineration disposal apparatus or a discarding apparatus for releasing the boil-off gas to the atmosphere.

The boil-off gas reliquefaction line 4 includes a boil-off gas return pipe 41 inserted through the liquefied gas tank 2 into the liquefied gas 21, and a pressure holding device 42 for condensing and trapping the boil-off gas 22 and releasing the boil-off gas 22 in liquid form into the liquefied gas 21. In the figure, only part of the boil-off gas return pipe 41 is illustrated and also the piping constituting the boil-off gas reliquefaction line 4 is illustrated in a simplified manner.

The boil-off gas return pipe 41 branches off from the boil-off gas discharge line 3, is inserted through the tank dome 2b of the liquefied gas tank 2 into the liquefied gas tank 2 and immersed in the liquefied gas 21. The boil-off gas return pipe 41 has a vertical portion 41a extending nearly vertically and partly immersed in the liquefied gas 21, and a horizontal portion 41b bent so as to extend in a nearly horizontal direction. The vertical portion 41a is immersed in the liquefied gas 21 to a depth M, and the horizontal portion 41b has a length N. The depth M is set so that the lower end of the vertical portion 41a may be located near the bottom of the liquefied gas tank 2 distant from the liquid surface of the liquefied gas 21, in order to maintain high heat exchange effectiveness over a long time. Also, that portion of the boil-off gas return pipe 41 which is immersed in the liquefied gas 21 has a length L (i.e. the sum of the depth M to which the vertical portion 41a is immersed and the length N of the horizontal portion 41b), and the length L is set so as to be able to release an amount of heat necessary for reliquefying the boil-off gas 22.

The boil-off gas return pipe 41 may be laid out such that the boil-off gas is introduced into the liquefied gas tank 2 from a location other than the tank dome 2b (e.g. side wall or bottom wall of the liquefied gas tank 2). Also, where the liquefied gas tank 2 is not provided with the tank dome 2b, the boil-off gas return pipe 41 may be configured so that the boil-off gas may be guided into the liquefied gas tank 2 from the roof part, side wall or bottom wall of the liquefied gas tank 2.

Operation of the boil-off gas processing apparatus 1 will now be described with reference to FIG. 2. In the pressure-enthalpy diagram of FIG. 2, the horizontal axis indicates enthalpy (kJ/kg), and the vertical axis indicates pressure (kPa). Also, in the figure, a curve in the center represents a vapor-liquid equilibrium curve 100, curves extending from top left to bottom right across the vapor-liquid equilibrium curve 100 represent isothermal curves 101, and curves extending toward top right represent isentropic curves 102. For the isothermal curves 101 and the isentropic curves 102, only those necessary for the explanation are shown in the figure. An area inside the vapor-liquid equilibrium curve 100 denotes a vapor-liquid mixed phase, an area on the left side of the vapor-liquid equilibrium curve 100 denotes a liquid phase, and an area on the right side of the vapor-liquid equilibrium curve 100 denotes a vapor phase.

Even if the liquefied gas tank 2 is provided with heat insulation, heat penetrates into the interior of the tank from outside to no small extent, and the liquefied gas evaporates due to the penetration heat, generating the boil-off gas 22. As the boil-off gas 22 is generated, the gas vapor pressure in the liquefied gas tank 2 rises, and the liquefied gas 21 in the liquefied gas tank 2 reaches a vapor-liquid equilibrium at a saturated vapor pressure dependent on the surface temperature of the liquefied gas. Also, the liquefied gas 21 warmed by the penetration heat collects in the surface region of the liquid in the liquefied gas tank 2 due to the convection accompanying temperature rise, forming a high-temperature liquid layer (upper high-temperature layer 21a) higher in temperature than the liquefied gas 21 as a whole, as shown in FIG. 1A. A liquid layer (lower low-temperature layer 21b) larger in amount and lower in temperature than the upper high-temperature layer 21a is formed under the upper high-temperature layer 21a.

Let it be assumed that in the liquefied gas tank 2, the liquefied gas 21 and the boil-off gas 22 are in a state A of vapor-liquid equilibrium. Since heat penetrating into the liquefied gas tank 2 is substantially concentrated at the upper high-temperature layer 21a, the liquid (liquefied gas 21) in the upper high-temperature layer 21a absorbs an amount Δh1 of the penetration heat, whereupon a transition to a state B takes place and the liquid turns to the boil-off gas 22 in order to maintain a vapor-liquid equilibrium state.

When the boil-off gas processing apparatus 1 is put into operation, the pressure of the boil-off gas 22 is increased by the compressor 32, so that the state of the boil-off gas 22 shifts, for example, to a state C. In the diagram, the state of the boil-off gas changes nearly along the isentropic curves 102. In practice, however, perfect adiabatic compression is not attained because of heat transfer from the piping and the like, and the state of the boil-off gas does not always change along the isentropic curves 102. As a result of the pressure increase accompanying the transition to the state C, the boil-off gas 22 absorbs an amount Δh2 of heat. An isothermal curve 101c passing through the state C indicates a temperature higher than that indicated by an isothermal curve 101a passing near the state A. Where the liquefied gas 21 is liquefied methane gas, for example, the isothermal curve 101a represents approximately −160° C., and the isothermal curve 101c represents approximately −120° C. The temperature in the state C can be accurately calculated on the basis of the properties of the natural gas, the pressure, properties and the like of the boil-off gas 22.

Let us now consider the case where the boil-off gas 22 in the state C is introduced into the liquefied gas 21 in the liquefied gas tank 2 through the boil-off gas return pipe 41 of the boil-off gas reliquefaction line 4. The boil-off gas 22 passes through the vertical portion 41a of the boil-off gas return pipe 41 to the depth M, then reaches a state D or a supercooled state on the same straight line while being transferred through the horizontal portion 41b, and released into the liquefied gas 21 in the liquefied gas tank 2. In this case, the boil-off gas 22 transferred to the depth M releases an amount Δh3 of heat to the low-temperature liquefied gas 21 in the lower low-temperature layer 21b, condenses and liquefies. The liquefied gas 21 in the lower low-temperature layer 21b is not yet in the state of the liquefied gas 21 in the upper high-temperature layer 21a which is in an equilibrium state at a higher pressure, and has the temperature of the isothermal curve 101a lower than the temperature in the state A.

The pressure in the boil-off gas return pipe 41 is set to a pressure Pd at which the boil-off gas 22 and the lower low-temperature layer 21b have such a temperature difference that the boil-off gas 22 can release the amount Δh3 of heat necessary for the liquefaction of the boil-off gas 22. That is, the pressure Pd in the boil-off gas return pipe 41 is set so that the necessary amount of heat can be transferred in a required time for liquefaction to the lower low-temperature layer 21b from the boil-off gas 22 in transition from the state C to the state D on the vapor-liquid equilibrium curve 100, and the pressure holding device 42 is attached to the terminal end of the boil-off gas return pipe 41 in order to maintain the pressure Pd. The aforementioned length L of the boil-off gas return pipe 41 is set to a length such that the boil-off gas 22, from which heat is transferred per time dependent on the pressure Pd, releases the amount Δh3 of heat necessary for all of the boil-off gas 22 to shift to the state D, and where the boil-off gas reliquefaction line 4 is to reliquefy all of the boil-off gas 22 and release the reliquefied boil-off gas into the liquefied gas 21, the length L is set to a length necessary for completely liquefying the boil-off gas 22.

One Pa nearly equals 1 atmosphere (about 101 kPa), and where the liquefied gas tank 2 stores the liquefied gas 21 under ordinary pressure, the pressure Pd may, for example, be 2 to 4 atmospheres (about 202 kPa to about 404 kPa) at most.

Subsequently, the reliquefied boil-off gas 22 is released into the liquefied gas 21, and as it is mixed with the liquefied gas 21 in the lower low-temperature layer 21b, the reliquefied boil-off gas 22 releases an amount of heat equivalent to Δh4 and is uniformized with the liquefied gas in the lower low-temperature layer 21b. It is possible that the reliquefied boil-off gas 22, which is released into the liquefied gas 21 while being in the state D or a supercooled state, may evaporate due to adiabatic expansion, but the evaporated boil-off gas 22 releases the amount Δh4 of heat and finally liquefies before reaching the upper high-temperature layer 21a.

In the aforementioned process of reliquefying the boil-off gas 22, the temperature of the liquefied gas 21 in the liquefied gas tank 2 slightly rises because the liquefied gas 21 absorbs heat in the amount of Δh3 plus Δh4. However, since the liquefied gas 21 in the lower low-temperature layer 21b is significantly large in amount and also since it takes a long time for the temperature of the liquefied gas 21 as a whole to rise, the temperature rise accompanying the reliquefaction of the boil-off gas 22 is dispersed throughout the liquefied gas 21 and exerts no practical influence.

The boil-off gas 22 may be released into the liquefied gas 21 while being in a vapor-liquid mixed phase in the middle of the transition from the state C to the state D, shown in FIG. 2. This means that the boil-off gas 22 may be released into the liquefied gas 21 with part of the boil-off gas 22 reliquefied by the boil-off gas reliquefaction line 4. Partial reliquefaction of the boil-off gas 22 is effective, for example, in cases where the transfer pressure under which the boil-off gas 22 is transferred through the boil-off gas reliquefaction line 4 is low or where the boil-off gas 22 need not be completely reliquefied.

In the aforementioned reliquefaction process for the boil-off gas 22, the boil-off gas 22 in the liquefied gas tank 2, of which the internal pressure has been raised by the penetration heat, is reliquefied and returned to the lower low-temperature layer 21b, so that the penetration heat stored in the upper high-temperature layer 21a is dispersed into the lower low-temperature layer 21b to be stored therein. That is to say, the boil-off gas processing apparatus 1 acts just like a pressure accumulator. Thus, by equipping the liquefied gas tank 2 with the boil-off gas processing apparatus 1, it is possible to prolong the period of time over which the internal pressure of the tank remains below the upper-limit predetermined pressure, even if the liquefied gas tank 2 is an atmospheric storage tank.

Also, the aforementioned boil-off gas processing apparatus 1 has only to be provided with the boil-off gas reliquefaction line 4 and does not require a special reliquefying apparatus, thus making it possible to reduce the facility cost and operating cost associated with the processing of the boil-off gas 22. Further, the boil-off gas 22 in gas vapor phase can be discharged so that the pressure in the liquefied gas tank 2 may not reach the predetermined pressure, and the discharged boil-off gas 22 can be reliquefied and returned to the liquefied gas tank 2, whereby incineration or discard of the boil-off gas 22 can be restrained.

For the pressure holding device 42, a vapor trap shown in FIG. 1A is used, for example. FIG. 1B illustrates a float type vapor trap (pressure holding device 42). The vapor trap includes, for example, a body 42a, a float type on-off valve 42b capable of vertically sinking and floating within the body 42a, a liquid discharging orifice 42c through which the liquefied gas is discharged, and a discharge port 42d from which the discharged liquid is released to outside.

The boil-off gas 22 and the reliquefied boil-off gas 22 transferred from the boil-off gas return pipe 41 are temporarily stored in the body 42a, and when the liquid stored in the body 42a reaches a certain amount, the float type on-off valve 42b rises and opens the liquid discharging orifice 42c, allowing the liquid to be discharged into the discharge port 42d. As the liquid in the body 42a decreases, the float type on-off valve 42b descends and closes the liquid discharging orifice 42c.

By providing the boil-off gas reliquefaction line 4 with the vapor trap (pressure holding device 42), it is possible to easily keep the internal pressure of the boil-off gas return pipe 41 at the pressure Pd and also to release the boil-off gas 22 in a completely liquefied state into the liquefied gas tank 2. The pressure holding device 42 to be used is not limited to the illustrated one and may be replaced by any desired device insofar as it is capable of keeping the internal pressure of the boil-off gas return pipe 41 at the pressure Pd, such as a vapor trap with a different structure, a simple device utilizing the pressure difference across the device, such as an orifice, or a pressure regulating valve.

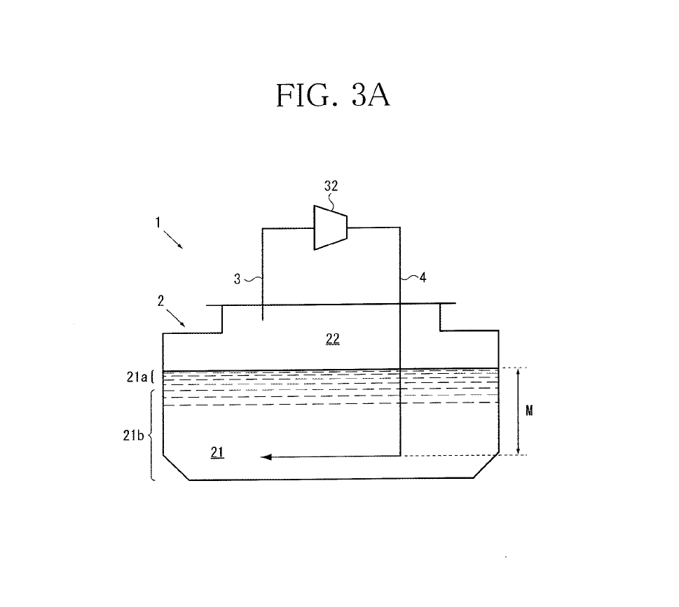

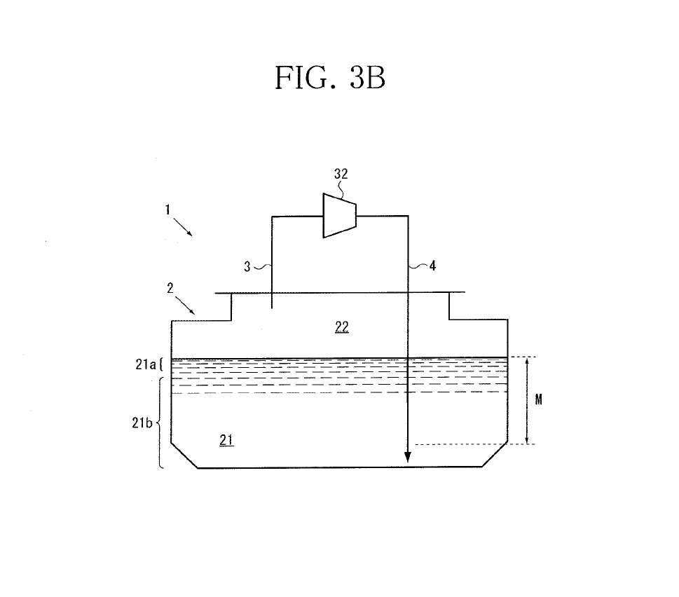

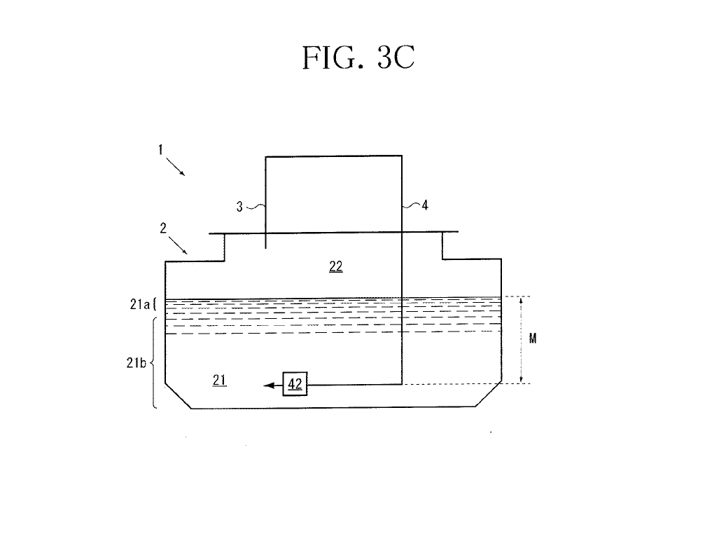

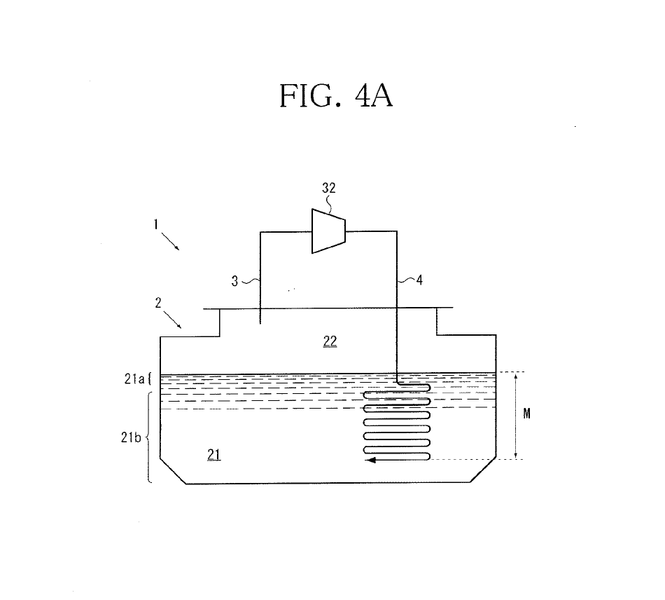

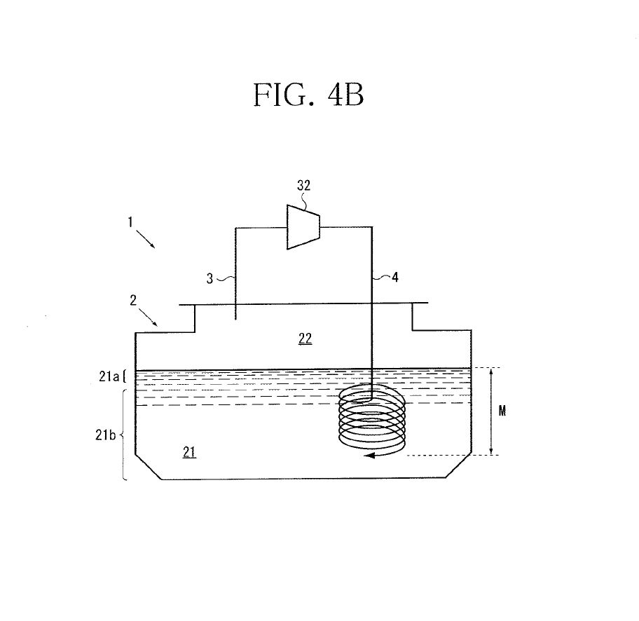

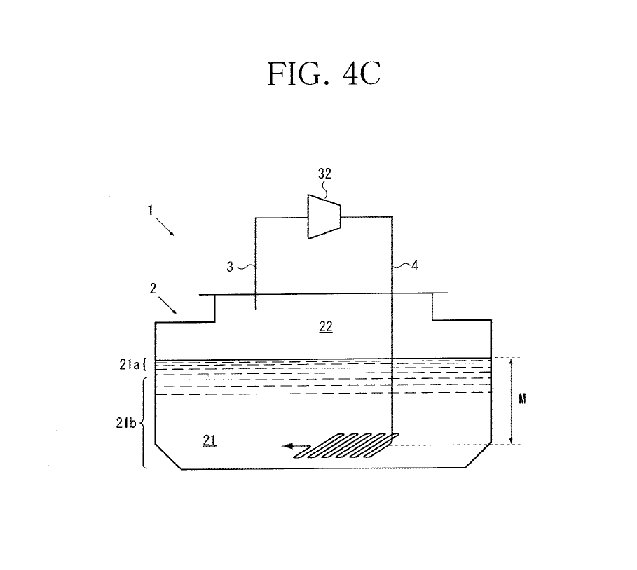

Modifications of the boil-off gas processing apparatus 1 of the first embodiment will now be described. FIG. 3 illustrates modifications of the boil-off gas processing apparatus shown in FIG. 1, wherein FIG. 3A illustrates a first modification, FIG. 3B illustrates a second modification, and FIG. 3C illustrates a third modification. FIG. 4 also illustrates modifications of the boil-off gas processing apparatus shown in FIG. 1, wherein FIG. 4A illustrates a fourth modification, FIG. 4B illustrates a fifth modification, and FIG. 4C illustrates a sixth modification. Identical reference signs are used to denote component parts or elements identical with those of the boil-off gas processing apparatus 1 of the first embodiment, and explanation of such component parts or elements is omitted. Also, in the individual figures, illustration of the boil-off gas discharge pipe 31 and boil-off gas return pipe 41 is omitted.

The first modification illustrated in FIG. 3A differs from the first embodiment in that the pressure holding device 42 is dispensed with. The pressure holding device 42 such as a vapor trap can be dispensed with in cases where the liquefied gas 21 stored in the liquefied gas tank 2 has a sufficient height, or depth, so that the boil-off gas 22 can be condensed by the static pressure of the liquefied gas 21 ascribable to gravity, or where the boil-off gas reliquefaction line 4 has a length L sufficient to liquefy the boil-off gas 22.

In the second modification illustrated in FIG. 3B, the boil-off gas reliquefaction line 4 of the first modification is configured so as to extend straight in the liquefied gas 21 stored in the liquefied gas tank 2. Where the liquefied gas tank 2 has a sufficient height, the boil-off gas reliquefaction line 4 may be configured such that the relationship of depth M=length L is fulfilled.

The third modification illustrated in FIG. 3C differs from the first embodiment in that the compressor 32 is dispensed with. Where the boil-off gas 22 can be returned to the liquefied gas 21 in the liquefied gas tank 2 solely by the gas vapor pressure in the liquefied gas tank 2, the compressor 32 for discharging the boil-off gas 22 or increasing the pressure of the boil-off gas 22 may be dispensed with.

In the fourth modification illustrated in FIG. 4A, the boil-off gas reliquefaction line 4 is configured such that the portion thereof immersed in the liquefied gas 21 meanders. The boil-off gas reliquefaction line 4 (specifically, the boil-off gas return pipe 41) with such a shape can improve heat exchange effectiveness in reliquefying the boil-off gas 22.

In the fifth modification illustrated in FIG. 4B, the boil-off gas reliquefaction line 4 is configured such that the portion thereof immersed in the liquefied gas 21 is coiled. The boil-off gas reliquefaction line 4 (specifically, the boil-off gas return pipe 41) with such a shape can improve heat exchange effectiveness in reliquefying the boil-off gas 22.

In the sixth modification illustrated in FIG. 4C, the boil-off gas reliquefaction line 4 is configured such that the horizontal portion (specifically, the horizontal portion 41b of the boil-off gas return pipe 41) meanders. Also with such a configuration, it is possible to improve heat exchange effectiveness in reliquefying the boil-off gas 22. The horizontal portion of the boil-off gas reliquefaction line 4 may be coiled as in the fifth modification, though not shown.

In the fourth to sixth modifications explained above, the pressure holding device 42 such as a vapor trap may be additionally provided or the compressor 32 may be dispensed with. Also, in the aforementioned first through sixth modifications, the boil-off gas consumption line 5 is not illustrated in the respective figures. The boil-off gas consumption line 5 may be additionally provided as in the first embodiment, or may be dispensed with if unnecessary.

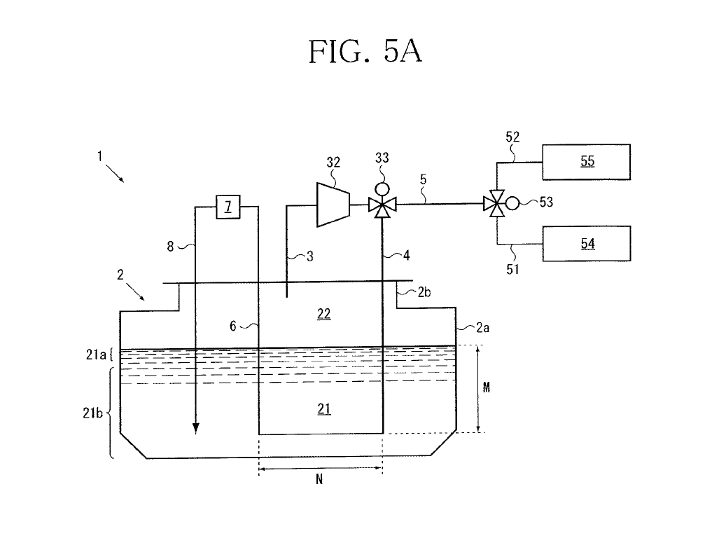

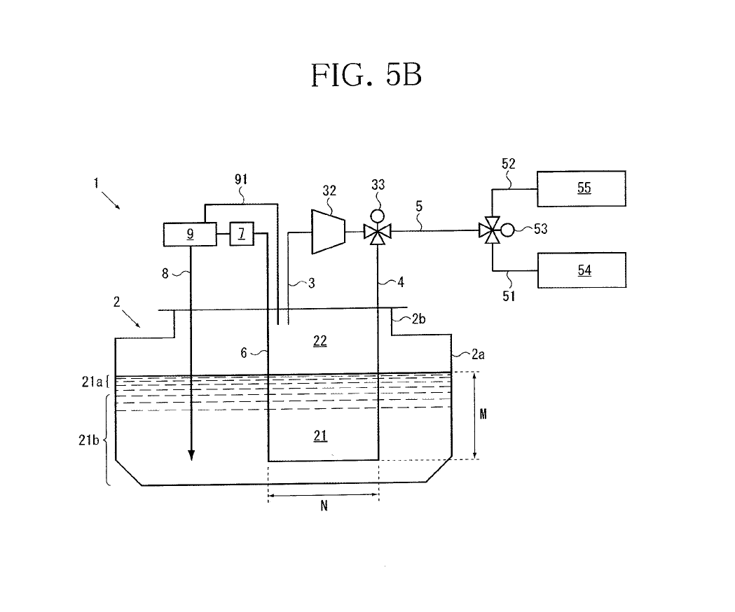

A boil-off gas processing apparatus 1 according to a second embodiment of the present invention will now be described. FIG. 5 illustrates the boil-off gas processing apparatus according to the second embodiment of the present invention, wherein FIG. 5A schematically illustrates an overall configuration of the apparatus, and FIG. 5B illustrates a modification of the apparatus. Identical reference signs are used to denote component parts or elements identical with those of the boil-off gas processing apparatus 1 of the first embodiment, and explanation of such component parts or elements is omitted. Also, in the individual figures, illustration of the boil-off gas discharge pipe 31 and boil-off gas return pipe 41 is omitted.

The boil-off gas processing apparatus 1 of the second embodiment illustrated in FIG. 5A additionally includes an outward guidance line 6 configured to guide the boil-off gas reliquefaction line 4 to the outside of the liquefied gas tank 2, a pressure holding device 7 attached to the distal end of the outward guidance line 6 and configured to condense and trap the boil-off gas 22 and release the boil-off gas 22 in liquid form, and a return line 8 configured to return the liquid released from the pressure holding device 7 into the liquefied gas 21 within the liquefied gas tank 2. According to the second embodiment, the pressure holding device 7 need not be placed in a low-temperature region at approximately −160° C. (in the case where the liquefied gas 21 is LNG) and can be placed in a nearly ordinary pressure region. It is therefore possible to use, as the pressure holding device 7, a commercially available or even simpler vapor trap, an orifice, a pressure regulating valve or the like. The pressure holding device 7 used may of course have a construction identical with that of the vapor trap shown in FIG. 1B. Further, according to the second embodiment, maintenance work can be performed on the pressure holding device 7 with the liquefied gas 21 stored in the liquefied gas tank 2.

The modification of the second embodiment, illustrated in FIG. 5B, additionally includes a liquid receiver tank 9 inserted between the pressure holding device and the return line 8 to temporarily hold the liquid released from the pressure holding device 7. The liquid receiver tank 9 is connected with a communication line 91 connecting the interior of the liquefied gas tank 2 and the interior of the liquid receiver tank 9 to each other. The communication line 91 formed in this manner serves to equalize the gas vapor pressure in the liquid receiver tank 9 with that in the liquefied gas tank 2, so that the liquid in the liquid receiver tank 9 can be easily returned to the liquefied gas 21 in the liquefied gas tank 2. When needed, a pressure regulating valve or the like may be inserted in the return line 8 or the communication line 91 or both.

In the above description of the embodiments according to the present invention, the wordings “upper high-temperature layer 21a” and “lower low-temperature layer 21b” are used on the supposition that the boil-off gas 22 is not released to outside, or that although the boil-off gas 22 has been released to outside, the gas vapor pressure in the liquefied gas tank 2 is still higher than the pressure of the deep region of the liquefied gas tank 2. Where the gas vapor pressure in the liquefied gas tank 2 has been made equal to or lower than the saturated vapor pressure of the liquefied gas 21 in the deep region of the liquefied gas tank 2 by operating the boil-off gas processing apparatus 1 according to either one of the above embodiments, the upper high-temperature layer 21a and the lower low-temperature layer 21b can become indistinguishable from each other (e.g. the temperature of the state A shown in FIG. 2 becomes equal to or lower than the isothermal curve 101a), and the present invention is not intended to exclude such a situation. That is, the wordings “upper high-temperature layer 21a” and “lower low-temperature layer 21b” denote an upper high-temperature layer and a lower low-temperature layer, respectively, that are formed on the assumption that the boil-off gas 22 is not released to outside, and signify layers that are located above and below, respectively of the liquefied gas 21 without regard to their temperature. The upper high-temperature layer may be reworded as upper heat-collected layer or upper heat-accumulated layer, and the lower low-temperature layer may be reworded as lower liquefied gas layer.

The present invention is not limited to the foregoing embodiments and may of course be modified in various ways without departing from the scope of the invention, for example, by suitably applying the present invention to facilities and equipment where liquefied gases such as liquefied natural gas (LNG) and liquefied petroleum gas (LPG) are stored in liquefied gas fuel tanks as in tankers, import bases, stockpiling bases or marine vessels, by applying the present invention to liquefied gas tanks other than the atmospheric storage tank, or by appropriately combining the aforementioned embodiments and modifications for use.

### REFERENCE SIGNS LIST

1: boil-off gas processing apparatus
2: liquefied gas tank
3: boil-off gas discharge line
4: boil-off gas reliquefaction line
5: boil-off gas consumption line
6: outward guidance line
7, 42: pressure holding device
8: return line
9: liquid receiver tank
21: liquefied gas
22: boil-off gas
32: compressor

1. A boil-off gas processing apparatus which reliquefies a boil-off gas generated within a liquefied gas tank storing a liquefied gas and returns the reliquefied gas to an interior of the liquefied gas tank, the boil-off gas processing apparatus comprising:
a boil-off gas discharge line configured to discharge the boil-off gas from the liquefied gas tank to outside; and
a boil-off gas reliquefaction line configured to immerse at least part of the boil-off gas discharge line in the liquefied gas within the liquefied gas tank, wherein the boil-off gas reliquefaction line maintains a pressure necessary for reliquefaction of the boil-off gas and has a length sufficient to be able to release an amount of heat necessary for reliquefaction of the boil-off gas.

2. The boil-off gas processing apparatus according to claim 1, wherein the boil-off gas reliquefaction line includes a pressure holding device configured to condense and trap the boil-off gas and release the boil-off gas in liquid form into the liquefied gas.

3. The boil-off gas processing apparatus according to claim 1, wherein the boil-off gas reliquefaction line reliquefies all or part of the boil-off gas to be released into the liquefied gas.

4. The boil-off gas processing apparatus according to claim 1, further comprising: an outward guidance line configured to guide the boil-off gas reliquefaction line to outside of the liquefied gas tank; a pressure holding device attached to a distal end of the outward guidance line and configured to condense and trap the boil-off gas and release the boil-off gas in liquid form; and a return line configured to return the liquid released from the pressure holding device into the liquefied gas within the liquefied gas tank.

5. The boil-off gas processing apparatus according to claim 4, further comprising a liquid receiver tank inserted between the pressure holding device and the return line to temporarily hold the liquid released from the pressure holding device.

6. The boil-off gas processing apparatus according to claim 1, wherein the boil-off gas discharge line includes a compressor configured to discharge the boil-off gas or to increase pressure of the boil-off gas.

7. A liquefied gas tank comprising a heat-insulating container storing a liquefied gas,
wherein the liquefied gas tank is equipped with the boil-off gas processing apparatus according to claim 1.

8. A liquefied gas tank comprising a heat-insulating container storing a liquefied gas,
wherein the liquefied gas tank is equipped with the boil-off gas processing apparatus according to claim 2.

9. A liquefied gas tank comprising a heat-insulating container storing a liquefied gas,
wherein the liquefied gas tank is equipped with the boil-off gas processing apparatus according to claim 3.

10. A liquefied gas tank comprising a heat-insulating container storing a liquefied gas,
wherein the liquefied gas tank is equipped with the boil-off gas processing apparatus according to claim 4.

11. A liquefied gas tank comprising a heat-insulating container storing a liquefied gas,
wherein the liquefied gas tank is equipped with the boil-off gas processing apparatus according to claim 5.

12. A liquefied gas tank comprising a heat-insulating container storing a liquefied gas,
wherein the liquefied gas tank is equipped with the boil-off gas processing apparatus according to claim 6.
